(19) United States
(12) Patent Application Publication
(10) Pub. No.: US 2004/0158994 A1
(43) Pub. Date: Aug. 19, 2004

(54) Blade clamping device for jig saws

(76) Inventor: Cheng I Teng, Fengyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/781,768

(22) Filed: Feb. 20, 2004

Related U.S. Application Data
(63) Continuation-in-part of application No. 10/092,568, filed on Mar. 8, 2002, now abandoned.

(51) Int. Cl. B26B 1/00

(52) U.S. Cl. 30/337

(57) ABSTRACT

A blade clamping device for jig saws includes a drive shaft with a holder connected to a lower end of the drive shaft. A recess is defined in an outer surface of the holder for receiving a blade which includes two flat opposite surfaces. A C-shaped clamping member is pivotally connected to the holder by a pin wherein an angle larger than 90 degrees is clamped between an axis of the pin and a plane of the recess. A gap is defined between a pressing member that extends from an inside of the clamping member and the recess. The gap varies when the clamping member is pivoted at different positions so that a blade of different thickness can be clamped.

This is a Continuation-In-Part application of applicant's former patent application with the Ser. No. 10/092,568, filed on Mar. 8, 2002.

### FIELD OF THE INVENTION

### BACKGROUND OF THE INVENTION

A conventional clamping device for positioning the blade of a jig saw is shown in FIG. 11 and generally includes a recess 61 defined in a lower end of the drive shaft 60 of the jig saw and an end of the blade 80 is inserted in the recess 61. A passage is defined in the drive shaft 60 laterally and a positioning bolt 70 is inserted in the passage and securely contacts the blade 80 in the recess 61. By the positioning bolt 70, the blade 80 is securely positioned. However, the recess 61 can only receive the blade 80 which has a thickness located in a specific range. The movement of the blade 80 is perpendicular to the clamping force of the positioning bolt 70 so that the blade 80 is easily loosened during the operation of the jig saws. Besides, when replacing the blade 80, a screw driver is needed to unscrew the positioning bolt 70.

U.S. Pat. No. 4,594,781 discloses a blade clamping device wherein the blade includes a plurality of grooves and there are gaps between the blade and the blade clamping device. U.S. Pat. No. 6,105,260 discloses a blade that includes a hole for a projection to extend therethrough. The two blade clamping devices are designed to clamp the blade having a fixed thickness and require a period of time to fix or remove the blade.

The present invention intends to provide a blade clamping device that can clamp blades have different sizes of thickness easily.

### SUMMARY OF THE INVENTION

In accordance with one aspect of the present invention, there is provided a blade clamping device for jig saws and the blade clamping device comprises a drive shaft wherein a holder is connected to a lower end of the drive shaft and has a recess defined in an outer surface thereof for receiving a blade therein. A lug extends radially outward from the holder. A C-shaped clamping member is pivotally connected to the lug by a pin and a pressing member extends from an inside of the clamping member. A torsion spring is mounted to the pin and a first end of the torsion spring is engaged with the lug and a second end of the torsion spring is engaged with the inside of the clamping member.

The primary object of the present invention is to provide a blade clamping device for jig saws wherein the clamping member is pivotably mounted to the blade holder and has a pressing member to press the blade in position.

The present invention will become more obvious from the following description when taken in connection with the accompanying drawings which show, for purposes of illustration only, a preferred embodiment in accordance with the present invention

### BRIEF DESCRIPTION OF THE DRAWINGS

FIG. 1 is a perspective view to show a jig saw that is equipped with the blade clamping device of the present invention;

FIG. 2 is a perspective view to show the blade clamping device of the present invention;

FIG. 3 is an exploded view to show the blade clamping device of the present invention;

FIG. 4 is an exploded view to show a blade and the holder of the blade clamping device of the present invention;

FIG. 5 shows the blade is to be put in the recess in the holder of the blade clamping device of the present invention;

FIG. 6 is a perspective view to show the blade is clamped in the blade clamping device of the present invention;

FIG. 7 is a perspective view form another angle to show the blade clamping device of the present invention;

FIG. 8 is a bottom view to show the blade clamping device of the present invention;

FIG. 9-1 is an end view which shows a thicker blade is clamped by the blade clamping device of the present invention;

FIG. 9-2 is a cross sectional view taken from line B-B of FIG. 9-1;

FIG. 9-3 is a cross sectional view taken from line A-A of FIG. 9-1;

FIG. 10-1 is an end view which shows a thinner blade is clamped by the blade clamping device of the present invention;

FIG. 10-2 is a cross sectional view taken from line B-B of FIG. 10-1;

FIG. 10-3 is a cross sectional view taken from line A-A of FIG. 10-1, and

FIG. 11 is a cross sectional view to show a blade is clamped by a conventional blade clamping device.

### DETAILED DESCRIPTION OF THE PREFERRED EMBODIMENT

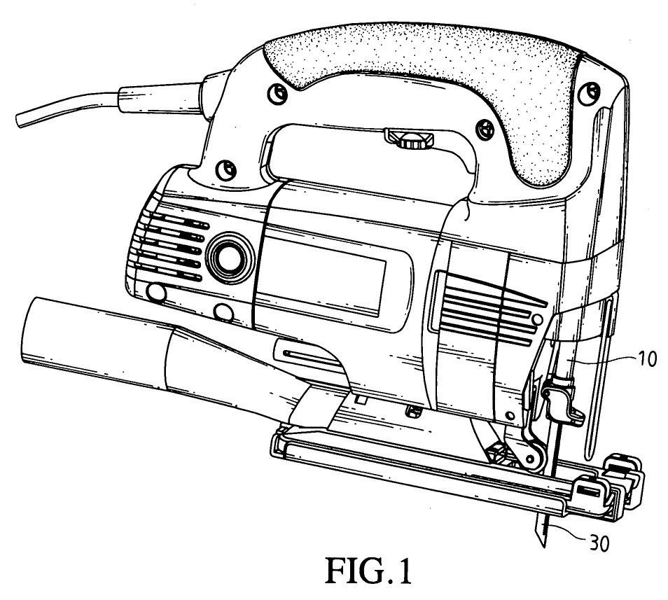

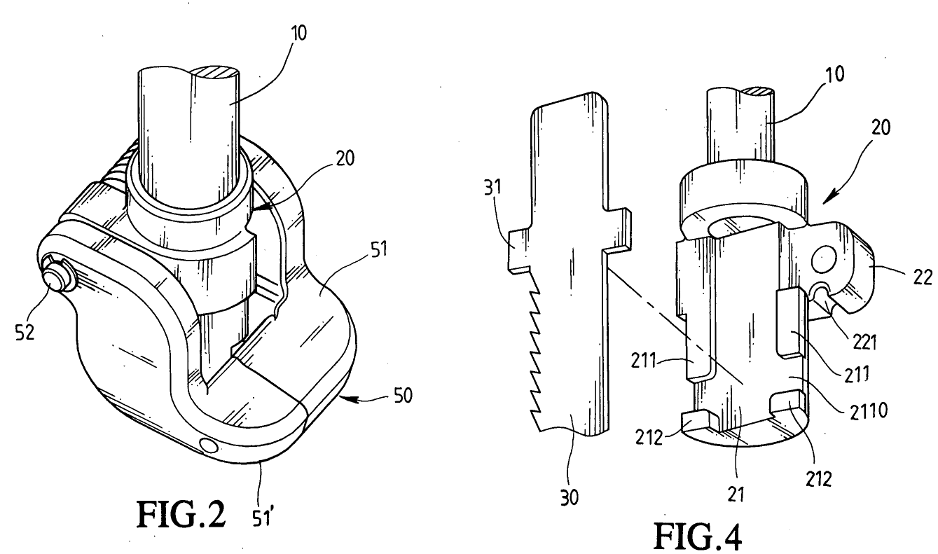

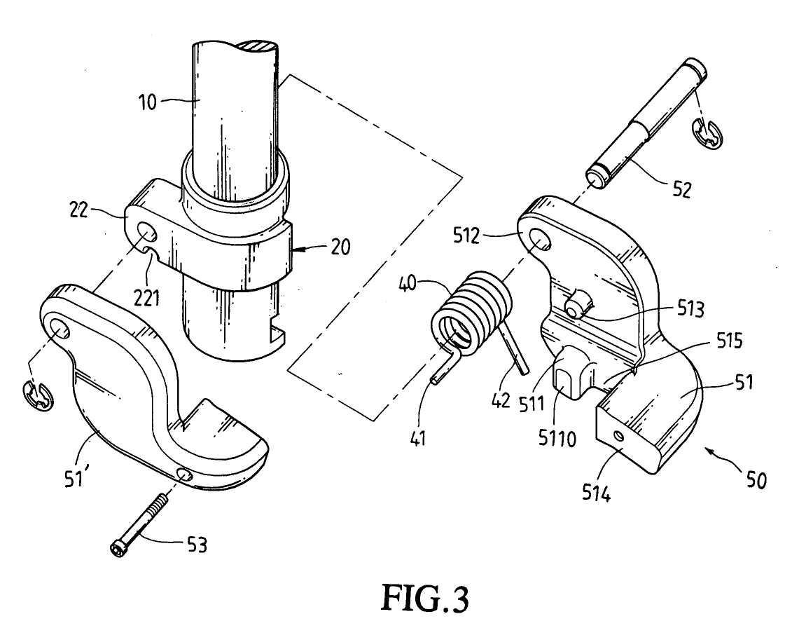

Referring to FIGS. 1 to 4, the blade clamping device for jig saws of the present invention comprises a drive shaft 10 and a holder 20 is connected to a lower end of the drive shaft 10. The holder 20, referring to FIG. 4, has an engaging surface defined in an outer surface thereof and two first side rails 211 extend from two sides of the engaging surface so as to define a recess 21. Two second side rails 212 are located in alignment with the first side rails 211 on the engaging surface of the holder 20 and a notch 2110 is defined between each one of the two aligned first side rail 211 and the second side rail 212. A blade 30 has two flat opposite surfaces and two wings 31 extending from two sides thereof and the blade 30 is received in the recess 21 with the two wings 31 engaged with two notches 2110 between the first side rails 211 and the two second side rails 212. The wings 31 are positioned in the notches 2110 so as to prevent vertical movement during operation. A lug 22 extends radially outward from the holder 20 and a hole is defined through the lug 22.

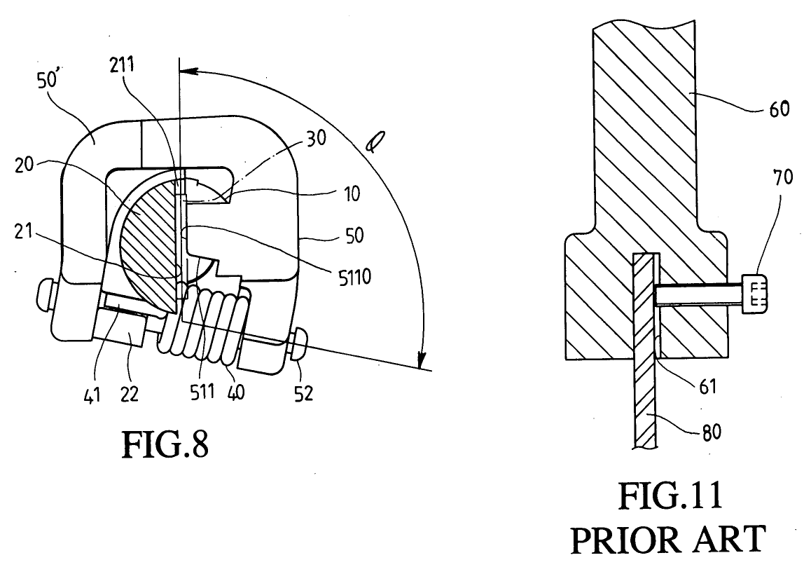

A C-shaped clamping member 50 composed of a first part 51 and a second part 51′ is pivotally connected to the lug 22 by a pin 52 extending through the hole in the lug 22 and the two respective first ends 512 of the first part 51 and the second part 51′. The other two respective second ends 514 of the first part 51 and the second part 51′ are connected by a screw 53. Further referring to FIG. 8, an angle “θ” that is larger than 90 degrees is clamped between an axis of the pin 52 extending through the lug 22 and a plane of the recess 21. The clamping member 50 can be pivoted away from the holder 20 about the pin 52.

A pressing member 511 and a protrusion 513 respectively extend from an inside 515 of the first part 51 of the clamping member 50. The inside 515 of the first part 51 of the clamping member 50 faces the recess 21 of the holder 20. A gap is defined between the end surface 5110 and the inside of the recess 21. The C-shaped clamping member 50 may also be made as an integral one-part member which is not shown.

A positioning member which can be a torsion spring 40 and is mounted to the pin 52 and a first end 41 of the torsion spring 40 is engaged with a notch 221 defined in a lower end of the lug 22 and a second end 42 of the torsion spring 40 is engaged with the protrusion 513 on the inside of the clamping member 50.

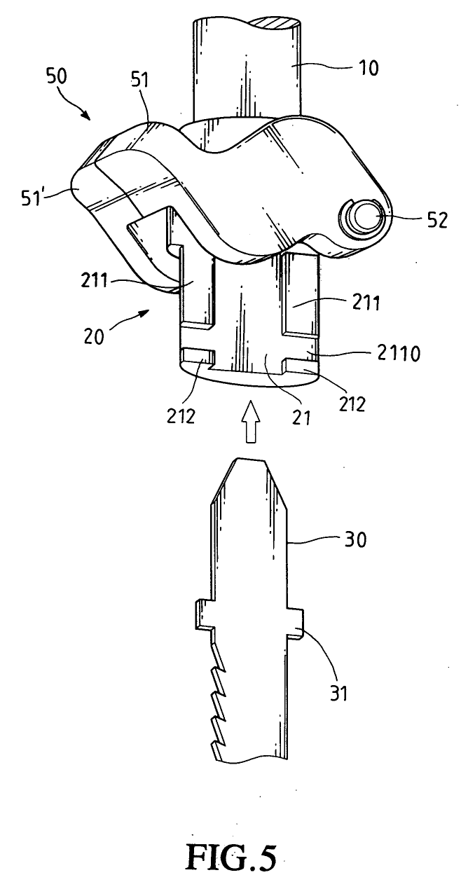

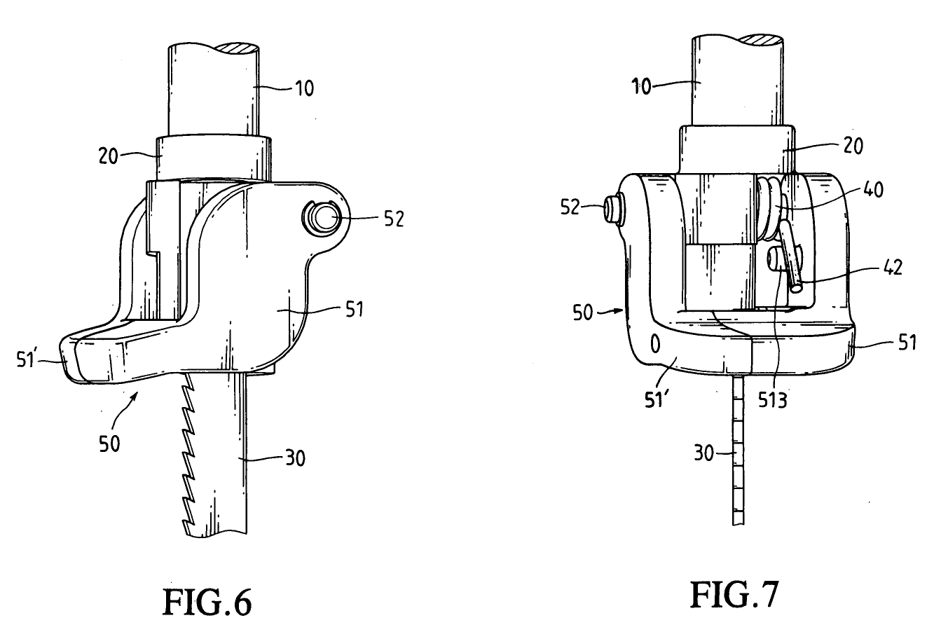

When pivoting the clamping member 50 upward as shown in FIG. 5, the recess 21 is exposed and the top end of the blade 30 is easily received in the recess 21. When releasing the clamping member 50 which is pivoted downward by the torsion spring 40 as shown in FIGS. 6 to 8. The pressing member 511 then securely contacts the blade 30 to position the blade 30. It is to be noted that because of the angle “0” between the axis of the pin 52 and the plane of the recess 21, the gap varies at different positions of the clamping member 50 when being pivoted so that the blade 30 of different thickness can be clamped. The end surface 5110 of the pressing member 511 is a flat surface so that one of the flat opposite surfaces of the blade 30 is urged by the flat end surface 5110 of the pressing member 511. This area of the end surface 5110 of the pressing member 511 is large enough so as to firmly position the blade 30 which will not have lateral movement.

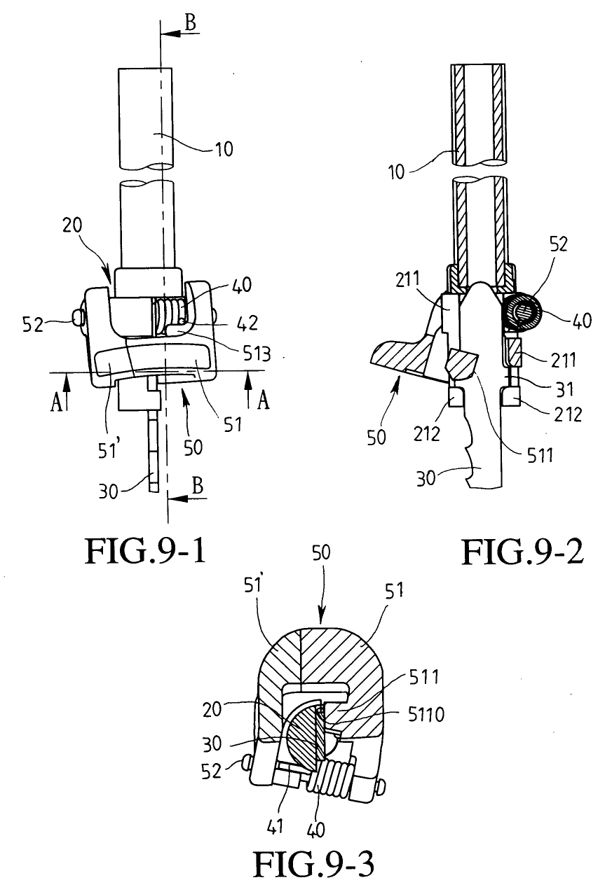

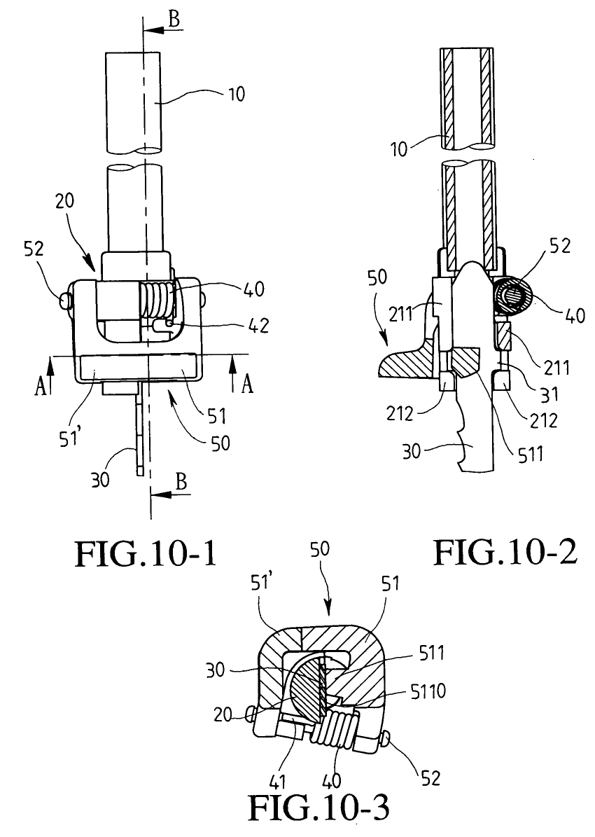

Referring to FIGS. 9-1, 9-2, and 9-3, when the blade 30 is a thicker blade, the second ends 514 of the first part 51 and the second part 51′ of the C-shaped clamping member 50 is stopped at a position higher than that if the blade 30 is a thinner one as shown in FIGS. 10-1, 10-2 and 10-3. The range of the thickness of the blade 30 is from 0.8 mm to 1.3 mm.

The blade clamping device does not need any tool and the blade 30 can be removed and re-clamped quickly. In addition, the blade 30 has two wings 31 which are restrained in the notches 2110 between the first side rails 211 and the second side rails 212 so that the blade 30 does not have lateral and vertical movement during operation.

While we have shown and described the embodiment in accordance with the present invention, it should be clear to those skilled in the art that further embodiments may be made without departing from the scope of the present invention.

What is claimed is:

1. A combination of a blade and a blade clamping device for jig saws, comprising:
a drive shaft;
a holder connected to a lower end of the drive shaft and having an engaging surface defined in an outer surface thereof,
two first side rails extending from two sides of the engaging surface so as to define a recess therebetween, two second side rails located in alignment with the first side rails on the engaging surface of the holder and a notch is defined between the aligned first side rails and the second side rails, a lug extending radially outward from the holder;
a C-shaped clamping member pivotally connected to the lug by a pin extending through two ends of the clamping member and the lug, an angle larger than 90 degrees being clamped between an axis of the pin and a plane of the recess, a pressing member extending from an inside of the clamping member and facing the inside of the recess of the holder, a gap defined between an end surface of the pressing member and the inside of the recess, a positioning member for securely positioning the clamping member onto the holder, and
a blade having two flat opposite surface and two wings extending from two sides of the blade, a top end of the blade being received in the recess between the first side rails and the second side rails of the holder, the two wings of the blade engaged with the notches between the aligned first side rails and the second side rails, an end surface of the pressing member being in contact with one of the flat opposite surfaces of the blade.

2. The combination as claimed in claim 1 wherein the positioning member is a torsion spring mounted to the pin, a first end of the torsion spring engaged with the lug and a second end of the torsion spring engaged with the inside of the clamping member.

3. The combination as claimed in claim 2 further comprising a notch defined in a lower end of the lug so that the first end of the torsion spring is engaged with the notch, a protrusion extending from the inside of the clamping member and the second end of the torsion spring being engaged with the protrusion.

4. The combination as claimed in claim 1, wherein the clamping member is composed of a first part and a second part, two respective first ends of the first part and the second part connected together by a screw and two respective second ends of the first part and the second part pivotally connected to the lug by the pin.

5. The combination as claimed in claim 1, wherein the end surface of the protrusion member is a flat surface.

6. The combination as claimed in claim 1, wherein the gap defined between an end surface of the pressing member and the inside of the recess varies when pivoting the clamping member about the pin.
